(19) United States
(12) Patent Application Publication
(10) Pub. No.: US 2025/0240056 A1
(43) Pub. Date: Jul. 24, 2025

(54) BEAMFORMING TRANSCEIVER DEVICE AND METHOD

(71) Applicant: Huawei Technologies Duesseldorf GmbH, Düsseldorf (DE)

(72) Inventors: Giuseppe Caire, Berlin (DE); Krishan Kumar Tiwari, Berlin (DE)

(73) Assignee: Huawei Technologies Duesseldorf GmbH, Düsseldorf (DE)

(21) Appl. No.: 19/172,851

(22) Filed: Apr. 8, 2025

Related U.S. Application Data
(63) Continuation of application No. PCT/EP2022/078076, filed on Oct. 10, 2022.

(51) Int. Cl. H04B 7/024; H04B 7/04

(52) U.S. Cl. CPC H04B 7/024; H04B 7/04013

(57) ABSTRACT

A transceiver device, including a multi-antenna feeder array and a reconfigurable intelligent surface (RIS), where the multi-antenna feeder array includes a plurality of active antennas configured to transmit electromagnetic radiation based on a data stream pre-coded with a pre-coder. The RIS includes a plurality of passive antennas, each passive antenna is configured to receive the electromagnetic radiation from the multi-antenna feeder array and to re-transmit the received electromagnetic radiation with a respective adjustable phase shift. The transmission from the plurality of active antennas of the multi-antenna feeder array to the plurality of passive antennas of the RIS is defined by a transmission matrix, where the multi-antenna feeder array is configured to generate the pre-coder based on one or more generalized eigenvectors of the transmission matrix.

### CROSS-REFERENCE TO RELATED APPLICATIONS

This application is a continuation of International Application No. PCT/EP2022/078076, filed on Oct. 10, 2022, the disclosure of which is hereby incorporated by reference in its entirety.

### FIELD

The present disclosure relates to communication technology such as a beamforming transceiver device and method for wireless communication.

### BACKGROUND

Applications requiring large bandwidths, such as extended reality (XR), digital twins, haptic technology, and the like, are driving the research for future wireless networks (commonly referred to as 6G) towards new and higher bandwidths, such as millimeter-wave (mmWave) and sub-teraHertz (sub-THz) technology. However, due to the large free-space isotropic spreading loss, the large absorption by blocking bodies, and the inability of going around corners by diffraction, mmWave/sub-THz communication channels are very sparse with the line of sight (LOS) path being the dominant component. For an increased range coverage, spatial focusing (generally referred to as beamforming) must be used in a targeted manner onto the desired communication target, for instance, a user equipment (UE). Such ultra-high gain beams can be formed by collecting the electromagnetic (EM) radiation, from a smaller active multi-antenna feeder (AMAF), over a much larger aperture. This large aperture can be created using discrete array elements implementing the spatial sampling which also allows electronic steering of the pencil beam. This approach, referred to as reflect-array with over-the-air (OTA) beamforming, is well-known and has been widely investigated.

More recently, with the advent of reconfigurable intelligent surfaces ((RIS), sometimes also referred to as reflective intelligent surfaces or transmissive intelligent surfaces) a new generation of reflect-arrays with electronically controlled steering capability has been suggested.

### SUMMARY

Aspects of the present disclosure provide an improved beamforming transceiver device and method for wireless communication.

A first aspect of the present disclosure includes a beamforming transceiver device for wireless communication. In an embodiment of the first aspect, the transceiver device comprises a multi-antenna feeder array with a plurality Na of active antennas configured to transmit electromagnetic radiation based on a data stream pre-coded with a beamforming pre-coder for beamforming the electromagnetic radiation. Moreover, the beamforming transceiver device comprises a reconfigurable intelligent surface (RIS) with a plurality Nₚ of passive antennas, wherein each passive antenna is configured to receive at least a portion of the electromagnetic radiation from the multi-antenna feeder array and to re-transmit the received electromagnetic radiation with a respective adjustable phase shift. The transmission from the plurality of active antennas of the multi-antenna feeder array to the plurality of passive antennas of the RIS is defined, i.e. described by a NₚxNₐ transmission matrix T. The multi-antenna feeder array is configured to generate the beamforming pre-coder to be applied to the data stream based on one or more generalized eigenvectors of the transmission matrix T. Thus, an improved transceiver device is provided for generating a high gain narrow beam with very small sidelobes. The transceiver device is capable of generating such high gain narrow beams with very small sidelobes with reduced power consumption compared with conventional devices. Moreover, because less hardware components are required, the transceiver device may be more lightweight and have an improved reliability compared with conventional devices. Because multiple orthogonal eigen modes including a second eigen mode having a very good mono-pulse null depth may be used, the transceiver device may be beneficially employed for mono-pulse angular tracking. Moreover, the transceiver device has improved flexibility because the multi-antenna feeder array and the RIS may be software controllable.

In a further possible implementation form, the multi-antenna feeder array is configured to generate the beamforming pre-coder to be applied to the data stream based on the one or more generalized eigenvectors of the transmission matrix T as a linear combination of the one or more generalized eigenvectors of the transmission matrix T. Thus, the transceiver device may efficiently generate wide angle beams, such as for sectorial illumination, beaconing, and the like.

In a further possible implementation form, the multi-antenna feeder array is configured to generate the beamforming pre-coder to be applied to the data stream based on the generalized eigenvector of the transmission matrix T having the largest generalized eigenvalue for a maximum power transfer from the multi-antenna feeder array to the RIS.

In a further possible implementation form, the distance between the RIS and the multi-antenna feeder array is smaller than the Rayleigh distance (also referred to as Rayleigh length) between the RIS and the multi-antenna feeder array.

In a further possible implementation form, the plurality of passive antennas of the RIS may be arranged on a substantially planar or curved surface.

In a further possible implementation form, the multi-antenna feeder array comprises a baseband processor for pre-coding the data stream with the pre-coder.

In a further possible implementation form, the transmission matrix T has a singular value decomposition, SVD, of the following form:

$$T = {\sum }_{i = 1}^{{N}_{a}} {σ}_{i} {u}_{i} {v}_{i}^{H} ,$$

wherein Nₐ denotes the number of active antennas, σᵢ denotes the i-th singular value, uᵢ denotes the i-th left singular vector and vᵢ^{H} denotes the Hermitian conjugate of the i-th right singular vector, wherein the one or more generalized eigenvectors are one or more left singular vectors and/or one or more right singular vectors of the SVD of the transmission matrix T. Moreover, the singular values σᵢ may be considered as eigenvalues of these generalized eigenvectors.

In a further possible implementation form, the RIS is configured to control the respective adjustable phase shift for re-transmitting the received electromagnetic radiation such that the electromagnetic radiation re-transmitted by the plurality of passive antennas coherently, i.e. constructively interferes in a desired target direction (i.e. the beamforming direction).

In a further possible implementation form, the number Nₚ of the plurality of passive antennas is substantially larger than the number Nₐ of the plurality of active antennas. For instance, the factor of the number Nₚ of the plurality of passive antennas to the number Nₐ of the plurality of active antennas may be at least larger than 10.

According to a second aspect of the present disclosure, a method for operating a transceiver device is disclosed, wherein the transceiver device comprises a multi-antenna feeder array with a plurality of active antennas configured to transmit electromagnetic radiation based on a data stream pre-coded with a pre-coder for beamforming the electromagnetic radiation, and a reconfigurable intelligent surface (RIS) with a plurality of passive antennas, wherein each passive antenna is configured to receive at least a portion of the electromagnetic radiation from the multi-antenna feeder array and to re-transmit the received electromagnetic radiation with a respective adjustable phase shift, wherein the transmission from the plurality of active antennas of the multi-antenna feeder array to the plurality of passive antennas of the RIS is defined, i.e. described by a transmission matrix T. The method comprises the step of generating the pre-coder to be applied to the data stream based on one or more generalized eigenvectors of the transmission matrix T.

The method according to the second aspect of the present disclosure can be performed by the transceiver device according to the first aspect of the present disclosure. Thus, further features of the method according to the second aspect of the present disclosure, result directly from the functionality of the transceiver device according to the first aspect of the present disclosure as well as its different implementation forms described above and below.

According to a third aspect of the present disclosure a computer program product is provided, comprising program code which causes a computer or a processor to perform the method according to the second aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram illustrating a beamforming transceiver device according to an embodiment of the present disclosure;

FIGS. 2a-2c show exemplary beam patterns generated by a transceiver device according to an embodiment of the present disclosure;

FIG. 3 shows a table listing values illustrating the performance of a transceiver device according to different embodiments of the present disclosure; and

FIG. 4 shows a flow diagram illustrating a method for operating a transceiver device according to an embodiment of the present disclosure.

In the following, identical reference signs refer to identical or at least functionally equivalent features.

### DETAILED DESCRIPTION

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

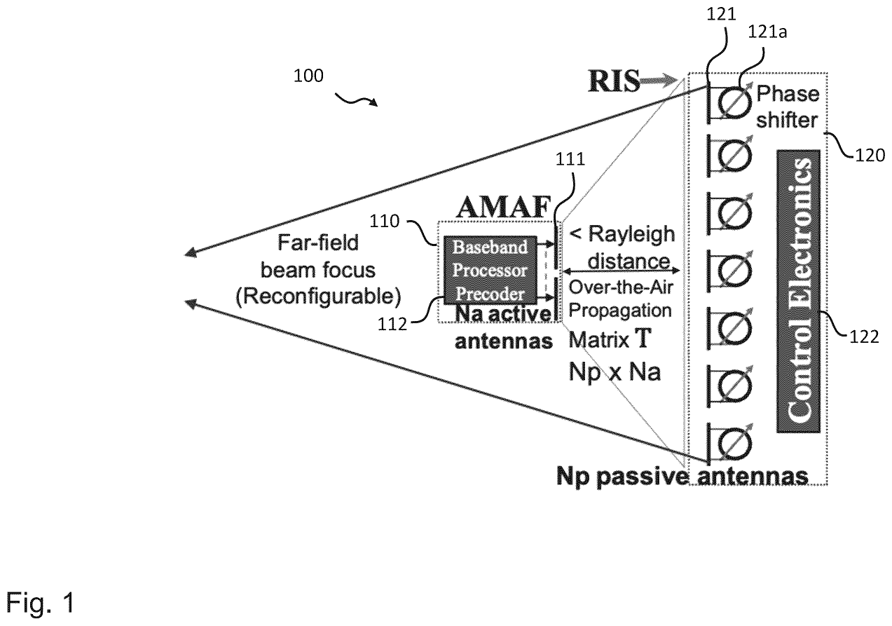

FIG. 1 shows schematically a beamforming transceiver device 100 according to an embodiment. In an embodiment, the transceiver device 100 may be, for instance, a base station or access point 100 configured for beamformed wireless communication with a plurality of user equipment or stations.

The transceiver device 100 comprises a multi-antenna feeder array 110 (referred to as active multi-antenna feeder (AMAF) in FIG. 1). The multi-antenna feeder array 110 comprises Nₐ active antennas 111 configured to transmit electromagnetic radiation based on a data stream pre-coded with a pre-coder for beamforming the electromagnetic radiation. In the embodiment shown in FIG. 1, the transceiver device 100 comprises a baseband processor 112 for generating the precoder and the driving signals for driving the plurality of active antennas 111. Each of the active antennas 111 may comprise a low noise amplifier (LNA) configured to amplify the driving signals for the active antennas 111. Although the following description of the transceiver device 100 according to an embodiment, focuses on the transmitting function of the transceiver device 100, it will be appreciated that the same concepts employed for the transmitting function of the transceiver device 100 may be applied for its receiving function.

The transceiver device 100 comprises a reconfigurable intelligent surface (RIS) 120. The RIS 120 comprises Nₚ passive antennas 121, wherein each passive antenna 121 is configured to receive at least a portion of the electromagnetic radiation from the multi-antenna feeder array 110 and to re-transmit the received electromagnetic radiation with a respective adjustable phase shift. To this end, the RIS 120 may comprise a respective phase shifter 121a for each of the Nₚ passive antennas 121 and a control unit 122 configured to adjust the phase shift applied by each phase shifter 121a to the electromagnetic radiation re-transmitted by each passive antenna 121. In an embodiment, the control unit 122 of the RIS 120 is configured to control the respective adjustable phase shift for re-transmitting the received electromagnetic radiation such that the electromagnetic radiation re-transmitted by the plurality of passive antennas 121 of the RIS 120 coherently, i.e. constructively interferes in a desired beamforming target direction.

As illustrated in FIG. 1, the plurality of passive antennas 121 of the RIS 120 may be arranged on a substantially planar surface of the RIS 120. Alternatively, the plurality of passive antennas 121 of the RIS 120 may be arranged on a curved surface of the RIS 120.

In the embodiment shown in FIG. 1 the passive antennas 121 of the RIS 120 are located within the near field of the active antennas 111 of the multi-antenna feeder array 110. In an embodiment, the distance between the RIS 120 and the multi-antenna feeder array 110 is smaller than the Rayleigh distance (also known as Rayleigh length) between the RIS 120 and the multi-antenna feeder array 110.

Mathematically, the transmission from the plurality of active antennas 111 of the multi-antenna feeder array 110 to the plurality of passive antennas 121 of the RIS 120 is defined, i.e. described by a NₚxNₐ transmission matrix T (which is also referred to as near-field propagation matrix T). The matrix elements T_{n,m} of the transmission matrix T are given by:

$${T}_{n , m} = \sqrt{{E}_{A} ( {θ}_{n , m} ) {E}_{R} ( {θ}_{n , m} )} exp ( j 2 π {r}_{n , m} / λ ) / ( 4 π {r}_{n , m} / λ )$$

wherein E_{A} denotes the gain of each active antenna 111, E_{R} denotes the gain of each passive antenna 121, r_{n, m} denotes the distance from the n-th active antenna 111 to the m-th passive antenna 121, λ denotes the carrier wavelength, θ_{n,m} denotes the angle of departure from the n-th active antenna 111 to the m-th passive antenna 121, and φ_{n,m} denotes the angle of arrival from the n-th active antenna 111 to the m-th passive antenna 121.

Further details of the transmission matrix T and its dependence on the active antennas 111 and the passive antennas 120 can be found in the paper Tiwari and Caire “On the Behavior of the Near-Field Propagation Matrix between two Antenna Arrays, with Applications to RIS-Based Over-the-Air Beamforming”, IEEE VTC2022, Spring, Helsinki, Finland, which is herein fully incorporated by reference.

As will be described in more detail below, the multi-antenna feeder array 110 is configured to generate the pre-coder to be applied to the data stream based on one or more generalized eigenvectors of the transmission matrix T. Likewise, for the receiving function of the transceiver device 100 the multi-antenna feeder array 110 may be configured to implement a combiner based on one or more generalized eigenvectors of the transmission matrix T.

As in most cases, the number Nₚ of the plurality of passive antennas 121 of the RIS 120 is substantially larger than the number Nₐ of the plurality of active antennas 111 of the multi-antenna feeder array, the NₚxNₐ transmission matrix T is a tall rectangular, i.e. a non-square matrix. As will be appreciated, although eigenvectors and eigenvalues are defined for square matrices, generalized eigenvectors may be defined for non-square matrices. For instance, in an embodiment, the one or more generalized eigenvectors may be one or more eigenvectors of the product of the transmission matrix with its Hermitian conjugate, i.e. TT^{H}, or one or more eigenvectors of T^{H}T.

In an embodiment of the present disclosure, the multi-antenna feeder array 110 is configured to generate the pre-coder to be applied to the data stream based on one or more generalized eigenvectors of the transmission matrix T based on a singular value decomposition (SVD) of the transmission matrix T, i.e.:

$$T = {USV}^{H} = {\sum }_{i = 1}^{{N}_{a}} {σ}_{i} {u}_{i} {v}_{i}^{H} ,$$

wherein Nₐ denotes the number of active antennas 111, σᵢ denotes the i-th singular value, uᵢ denotes the i-th left eigenvector and vᵢ^{H} denotes the Hermitian conjugate of the i-th right eigenvector, wherein the generalized eigenvalues are the singular values and wherein the one or more generalized eigenvectors are one or more left eigenvectors and/or one or more left eigenvectors of the SVD of the transmission matrix T. As will be appreciated, however, the multi-antenna feeder array 110 may generate the one or more generalized eigenvectors of the transmission matrix T for generating the precoder based on other matrix decompositions than the SVD, for instance, based on a geometric mean decomposition, a generalized tridiagonal decomposition, or a tunable channel decomposition of the transmission matrix T.

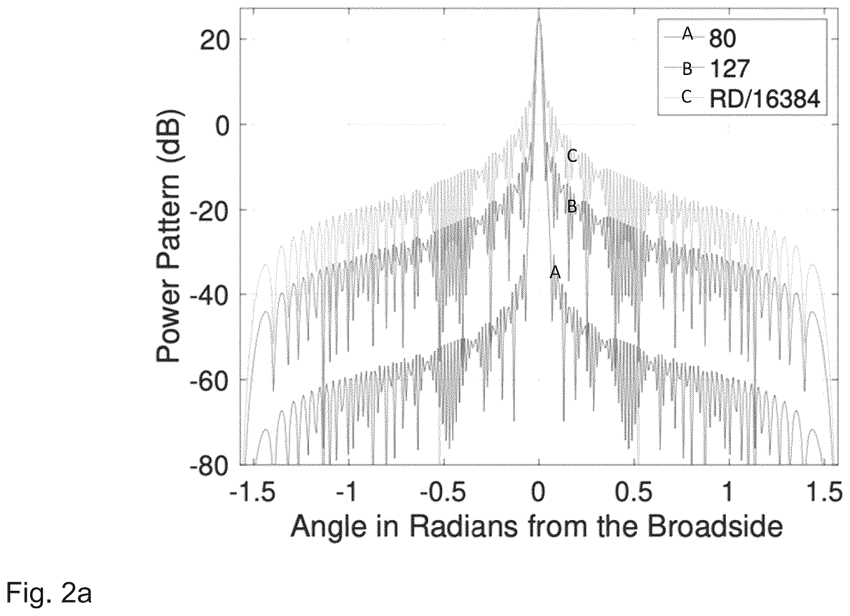

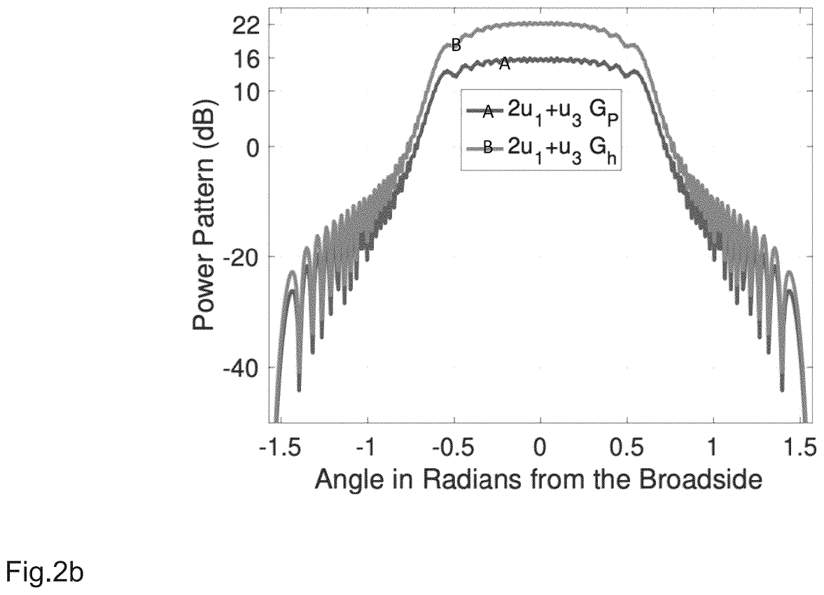

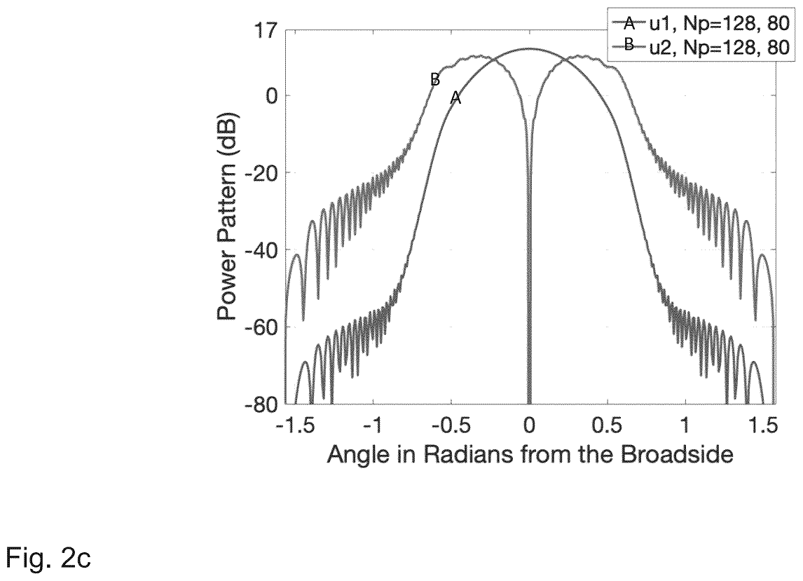

In an embodiment of the present disclosure, the multi-antenna feeder array 110 is configured to generate the pre-coder to be applied to the data stream based on the generalized eigenvector of the transmission matrix T having the largest generalized eigenvalue, which may be considered as the principal eigenmode of the transmission matrix T. In an embodiment, the generalized eigenvector of the transmission matrix T having the largest generalized eigenvalue may be the left singular or the right singular vector having the largest singular value σᵢ. FIG. 2a shows exemplary beam patterns generated by the transceiver device 100 according to an embodiment using the generalized eigenvector of the transmission matrix T having the largest generalized eigenvalue for different distances between the multi-antenna feeder array 110 and the RIS 120. As can be taken from FIG. 2a, the beams indicated by A, B, and C correspond to a respective distance between the AMAF 111 and the RIS 120 of 80 half-wavelengths, 127 half-wavelengths, and the Rayleigh distance.

In an embodiment of the present disclosure, the multi-antenna feeder array 110 is configured to generate the pre-coder to be applied to the data stream based on the one or more generalized eigenvectors of the transmission matrix T as a linear combination of the one or more generalized eigenvectors of the transmission matrix T. In an embodiment of the present disclosure, the one or more generalized eigenvectors may be one or more left singular and/or one or more right singular vectors of the SVD of the transmission matrix T. In other words, in an embodiment of the present disclosure, the multi-antenna feeder array 110 is configured to generate the pre-coder as a vector b of the form:

$$b = {\sum }_{i = 1}^{{N}_{a}} {β}_{i} {v}_{i}$$

wherein βᵢ denotes a coefficient, i.e. weight for the linear combination and vᵢ denotes a right singular or generalized eigen vector.

FIG. 2b shows an exemplary wide angle flat top beam pattern generated by the transceiver device 100 according to an embodiment of the present disclosure based on a linear combination of the principal and the third eigenmodes of the transmission matrix T. In FIG. 2b, A indicates the beam shape obtained from a microstrip patch antenna element having a half power beam width of 90 degrees, while B indicates the beam shape obtained from a higher directive antenna element with half power beam width of 65 degrees.

In an embodiment of the present disclosure, the transceiver device 100 may implement two radio frequency (RF) chains using the principal eigenmode and the second eigenmode (mutually orthogonal functions) to create two mutually orthogonal angle-domain radiation patterns illustrated in FIG. 2c (beam A shows the principal eigenmode, while beam B shows the second eigenmode). The monopulse null depth of B is more than 50 dB which enables very accurate angular tracking of a target, i.e. user without any hardware restructuring or any extra RF hardware. This facilitates joint communications and sensing by the transceiver device 100 according to an embodiment of the present disclosure. As will be appreciated, this feature works well for different AMAF-RIS distances in the near-field.

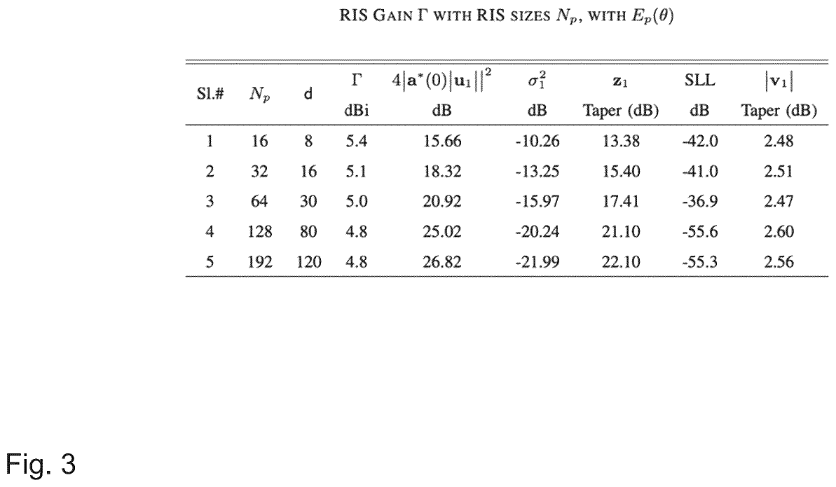

FIG. 3 shows a table listing values illustrating the performance of the transceiver device 110 according to different embodiments of the present disclosure. For example, the table in FIG. 3 lists the RIS gain Γ as well as some further parameters for the transceiver device 100 according to different embodiments of the present disclosure with different numbers Nₚ of passive antennas 121 and different distances d between the multi-antenna feeder array 110 and the RIS 120 based on numerical simulations. As can be taken from this table, the optimum AMAF-RIS distance d in the third column increases with the number Np of passive antennas 121 in the second column. As will be appreciated, the AMAF-RIS loss may be compensated almost exactly by the larger aperture gain of the RIS 120. It follows that one obtains roughly the same total center-beam gain for different beam selectivities, by choosing different numbers Np of passive antennas 121 (as can be taken from the fourth column of the table shown in FIG. 3).

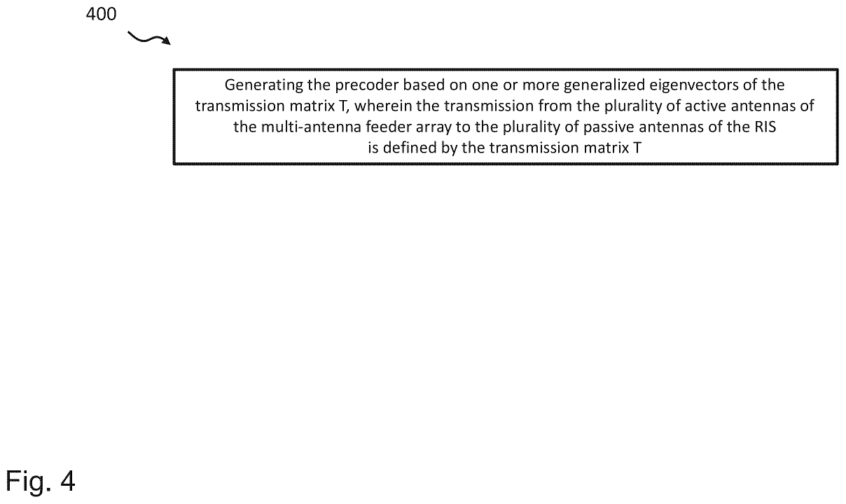

FIG. 4 shows a flow diagram illustrating a method 400 for operating the transceiver device 100 according to an embodiment. The method 400 comprises the step of generating the pre-coder to be applied to the data stream based on one or more generalized eigenvectors of the transmission matrix T.

The transceiver device 100 according to different embodiments of the present disclosure may be advantageously employed for a multitude of different use cases, such as generating targeted and steerable high gain beams for communications, angular tracking, sectorial illumination for joint communications and sensing, and the like.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present disclosure, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit.

1. A transceiver device, comprising:
a multi-antenna feeder array comprising a plurality of active antennas configured to transmit electromagnetic radiation based on a data stream pre-coded with a pre-coder; and
a reconfigurable intelligent surface (RIS), wherein the RIS comprises a plurality of passive antennas, wherein each passive antenna is configured to receive the electromagnetic radiation from the multi-antenna feeder array and to re-transmit the received electromagnetic radiation with a respective adjustable phase shift,
wherein the transmission from the plurality of active antennas of the multi-antenna feeder array to the plurality of passive antennas of the RIS is defined by a transmission matrix, and
wherein the multi-antenna feeder array is configured to generate the pre-coder based on one or more generalized eigenvectors of the transmission matrix.

2. The transceiver device of claim 1, wherein the multi-antenna feeder array is configured to generate the pre-coder based on the one or more generalized eigenvectors of the transmission matrix as a linear combination of the one or more generalized eigenvectors of the transmission matrix.

3. The transceiver device of claim 1, wherein the multi-antenna feeder array is configured to generate the pre-coder based on the generalized eigenvector of the transmission matrix having a largest generalized eigenvalue.

4. The transceiver device of claim 1, wherein the distance between the RIS and the multi-antenna feeder array is smaller than a Rayleigh distance between the RIS and the multi-antenna feeder array.

5. The transceiver device of claim 1, wherein the plurality of passive antennas of the RIS are arranged on a planar surface or curved surface.

6. The transceiver device of claim 1, wherein the multi-antenna feeder array further comprises a baseband processor for pre-coding the data stream with the pre-coder.

7. The transceiver device of claim 1, wherein the transmission matrix is a transmission matrix T that has a singular value decomposition; (SVD) of a form:
$$T = {\sum }_{i = 1}^{{N}_{a}} {σ}_{i} {u}_{i} {v}_{i}^{H} ,$$
wherein Nₐ denotes a number of active antennas, σᵢ denotes an i-th singular value, uᵢ denotes an i-th left singular vector, and vᵢ^{H} denotes a Hermitian conjugate of an i-th right singular vector, wherein the one or more generalized eigenvectors are at least one of one or more left singular vectors and one or more right singular vectors of the SVD of the transmission matrix T.

8. The transceiver device of claim 1, wherein the RIS is configured to control the respective adjustable phase shift such that the electromagnetic radiation re-transmitted by the plurality of passive antennas coherently interferes in a desired target direction.

9. The transceiver device of claim 1, wherein a number of the plurality of passive antennas is substantially larger than a number of the plurality of active antennas.

10. A method for operating a transceiver device, the transceiver device comprising a multi-antenna feeder array with a plurality of active antennas configured to transmit electromagnetic radiation based on a data stream pre-coded with a pre-coder, and a reconfigurable intelligent surface (RIS) with a plurality of passive antennas, wherein each passive antenna is configured to receive the electromagnetic radiation from the multi-antenna feeder array and to re-transmit the received electromagnetic radiation with a respective adjustable phase shift, wherein the transmission from the plurality of active antennas of the multi-antenna feeder array to the plurality of passive antennas of the RIS is defined by a transmission matrix, wherein the method comprises the step of:
generating the pre-coder based on one or more generalized eigenvectors of the transmission matrix.
